(19) United States
(12) Patent Application Publication
(10) Pub. No.: US 2025/0298844 A1
(43) Pub. Date: Sep. 25, 2025

(54) QUERYABLE ASSET MODEL ASSOCIATED WITH OPC UA AND GRAPH

(71) Applicant: Siemens Corporation, Washington, DC (US)

(72) Inventors: Yufeng Li, Wynnewood, PA (US); Anandrao Todkar, Plainsboro, NJ (US); Md Ridwan Iqbal, Plainsboro, NJ (US)

(73) Assignee: Siemens Corporation, Washington, DC (US)

(21) Appl. No.: 19/105,061

(22) PCT Filed: Aug. 31, 2022
(86) PCT No.: PCT/US2022/075728

§ 371 Date: Feb. 20, 2025

(51) Int. Cl. G06F 16/901; G06F 16/242; G06F 16/2458

(52) U.S. Cl. CPC G06F 16/9024; G06F 16/2433; G06F 16/2471

(57) ABSTRACT

Methods, systems, and apparatuses are configured to generate new industrial asset models that can be efficiently queried. The new industrial asset models can be tailored to specific users and represented in an RDF knowledge graph. In particular, the RDF graph can define variables that correspond to OPC variables. The RDF knowledge graph queried via a query that is compliant with a GraphQL API.

### BACKGROUND

Open Platform Communications, Unified Architecture (OPC UA) defines industry standard models that are often referred to as companion specifications because they typically address a specific industry problem. These specifications together with the basic OPC UA infrastructure allows exchange of information between industry models, thereby allowing interoperability at a semantic level for entities on a shop floor, as well as information technology (IT) systems in a given factory. The OPC UA standard is a cross-platform, open-source IEC62541 standard for data exchange between devices in industrial systems. OPC UA provides standard interfaces and semantics that enable interoperability among products from different suppliers in factories.

It is recognized herein, however, that searching for information in these models is often difficult for conventional IT systems. In particular, for example, the information represented in the OPC UA architecture can be difficult to query and search for other uses. One technique for providing queries to OPC UA is to convert the OPC UA ontology into a Resource Description Framework (RDF) knowledge graph. In some cases, RDF knowledge graphs can represent OPC UA specifications in a way that can be queried and searched. RDF typically uses SPARQL as a means to query an RDF database.

In the context of an industrial information hub (IIH), an asset can represent an industrial object that defines related connections and data. It is recognized herein, however, that current asset models are difficult to generate, query and/or learn, particular as asset models get more complex over time.

### BRIEF SUMMARY

Embodiments of the invention address and overcome one or more of the described-herein shortcomings or technical problems by providing methods, systems, and apparatuses for generating new industrial asset models that can be efficiently queried.

In an example aspect, based on user selections, a computing system comprising one or more asset modules can generate an industrial asset model comprising assets from a plurality of different sources. The assets ca be defined in accordance with an Open Platforms Communication United Architecture (OPC UA). The system can convert the assets from the OPC UA to a resource description format (RDF) knowledge graph. The system can store the RDF knowledge graph in a database. Furthermore, the system can receive a query for industrial data. Responsive to the query for industrial data, the system can extract, from the database, at least two of the assets from the plurality of sources, wherein the at least two assets are representative of the industrial data. In an example, the system can receive, via a Restful interface, a request associated with a change to the asset model. Responsive to the request, the system can adjust an asset of the asset model in accordance with the change, so as to define an adjusted asset. Additionally, the system can update the RDF graph in accordance with the adjusted asset. In various examples, the asset model defines an asset variable that subscribes to a respective OPC source of the asset variable. Based on subscribing to the OPC source, the system can identify a change to the OPC source, and update the asset variable responsive to identifying the change to the OPC source. In another example aspect, the system can receive the query that is compliant with a GraphQL API, so to define a GraphQL query. The system can convert the GraphQL query to a query compliant with SPARQL, so as to define a SPARQL query. The system can also format the at least two assets representative of the industrial data in a format selected by a user.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a block diagram of an example industrial system that includes an asset module in accordance with an example embodiment.

FIG. 2 illustrates an example asset model in accordance with prior art.

FIGS. 3A and 3B illustrate an example Representational State Transfer (REST) interface for querying asset models in accordance with the prior art.

FIG. 4 is a block diagram of a system configured to generate new asset models tailored to a particular user, in accordance with an example embodiment.

FIG. 5 is a block diagram that illustrates an example asset model and its relationship with an OPC model, in accordance with an example embodiment.

FIG. 6 illustrates an example system for querying asset models, in accordance with an example embodiment.

FIG. 7 shows an example of a computing environment within which embodiments of the disclosure may be implemented.

### DETAILED DESCRIPTION

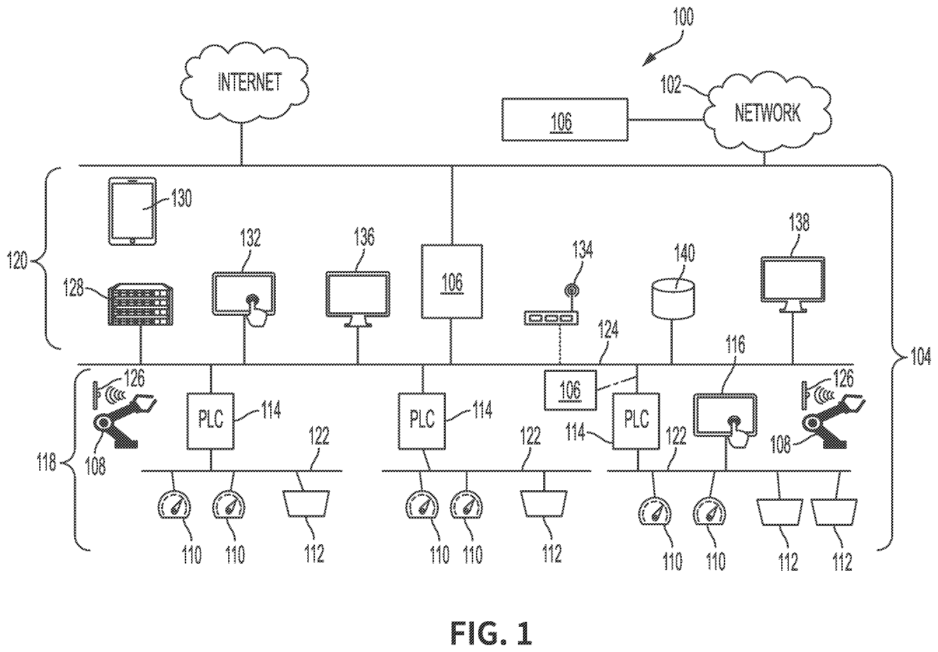

Referring initially to FIG. 1, an example industrial system 100 includes multiple subsystems that contain control logic, host web servers, and the like. For example, the industrial system can include an office or corporate IT network 102 and an operational plant or production network 104 communicatively coupled to the IT network 102. The production network 104 can include a plurality of asset modules 106 throughout the production network 104. An example asset module 106 is connected to the IT network 102. The arrangement of asset modules 106 can vary as desired, and all such arrangements are contemplated as being within the scope of this disclosure. For example, asset modules 106 can be distributed across production or IT networks. In various examples, the asset module 106 can define software that runs on components within the production network 104 and/or IT network 102. The production network 104 can include various production machines configured to work together to perform one or more manufacturing operations. Example production machines of the production network 104 can include, without limitation, robots 108 and other field devices that can be controlled by a respective PLC 114, such as sensors 110, actuators 112, or other machines, such as automatic guided vehicles (AGVs) 108. The PLC 114 can send instructions to respective field devices. In some cases, a given PLC 114 can be coupled to a human-machine interfaces (HMIs) 116. It will be understood that the industrial system 100 is simplified for purposes of example. That is, the industrial system 100 may include additional or alternative nodes or systems, for instance other network devices that define alternative configurations, and all such configurations are contemplated as being within the scope of this disclosure.

The industrial system 100, in particular the production network 104, can define a fieldbus portion 118 and an Ethernet portion 120. For example, and without limitation, the fieldbus portion 118 can include the robots 108, PLC 114, sensors 110, actuators 112, HMIs 116, and AGVs. The fieldbus portion 118 can define one or more production lines or control zones. The PLC 114, sensors 110, actuators 112, and HMI 116 within a given production line can communicate with each other via a respective field bus 122. Each control zone can be defined by a respective PLC 114, such that the PLC 114, and thus the corresponding control zone, can connect to the Ethernet portion 120 via an Ethernet connection 124. The robots 108 and AGVs can be configured to communicate with other devices within the fieldbus portion 118 via a Wi-Fi connection 126. Similarly, the robots 108 and AGVs can communicate with the Ethernet portion 120, in particular a Supervisory Control and Data Acquisition (SCADA) server 128, via the Wi-Fi connection 126. The Ethernet portion 120 of the production network 104 can include various computing devices or subsystems communicatively coupled together via the Ethernet connection 124. Example computing devices or subsystems in the Ethernet portion 120 include, without limitation, a mobile data collector 130, HMIs 132, the SCADA server 128, the control unit 106, a wireless router 134, a manufacturing execution system (MES) 136, an engineering system (ES) 138, and a log server 140. The ES 138 can include one or more engineering works stations. In an example, the MES 136, HMIs 132, ES 138, and log server 140 are connected to the production network 104 directly. The wireless router 134 can also connect to the production network 104 directly. Thus, in some cases, mobile users, for instance the mobile data collector 130 and robots 108 (e.g., AGVs), can connect to the production network 104 via the wireless router 134.

Example users of the automation or manufacturing system 100 include, for example and without limitation, operators of an industrial plant or engineers that can update the control logic of a plant. By way an example, an operator can interact with the HMIs 132, which may be located in a control room of a given plant. Alternatively, or additionally, an operator can interact with HMIs of the system 100 that are located remotely from the production network 104. Similarly, for example, engineers can use the HMIs 116 that can be located in an engineering room of the automation system 100. Alternatively, or additionally, an engineer can interact with HMIs of the automation 100 that are located remotely from the production network 104.

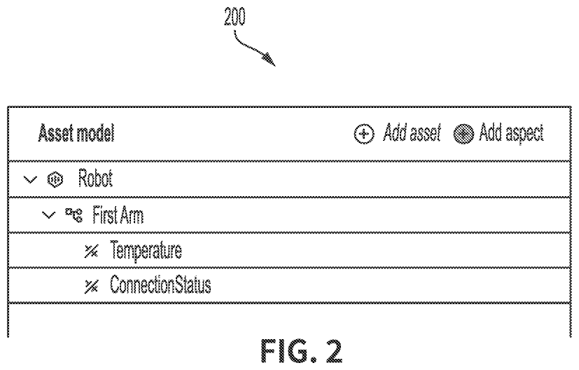

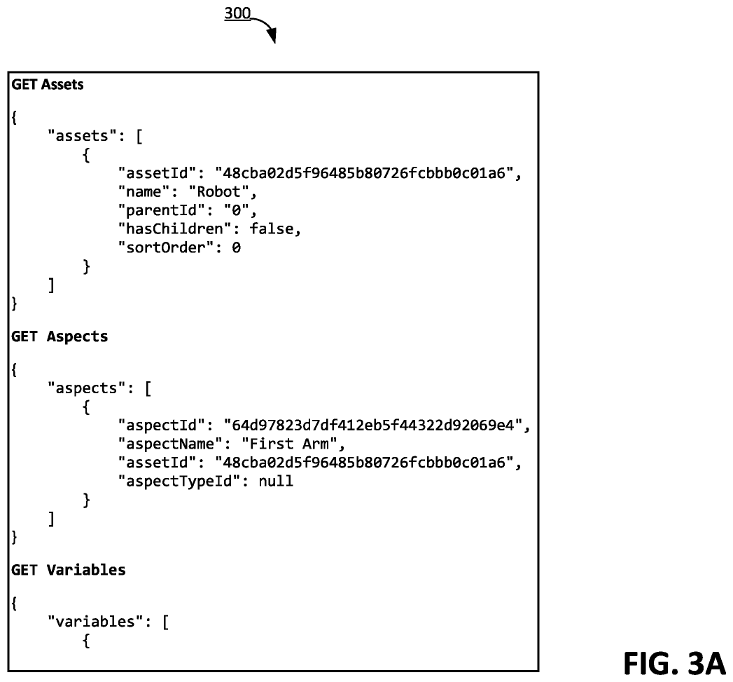

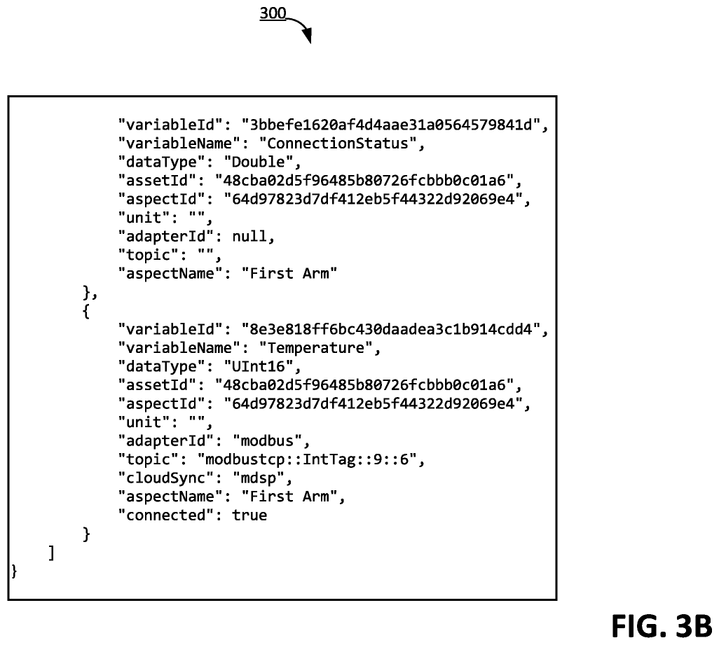

As an initial matter, referring to FIG. 2, it is recognized herein that current asset models, such as an Asset model 200, can be viewed using a Representational State Transfer (REST) interface, but these queries are simple and do not allow filtering, among other shortcomings. In particular, referring also to FIGS. 3A and 3B, example REST application program interfaces (APIs) 300 drive a user interface (UI) for querying the example asset model 200. As illustrated, the data response of the APIs 300 is in simple JavaScript Object Notation (JSON) format, such that there is no query ability to select the specific Asset, Aspect, or variable associated with certain criteria. To further illustrate the technical shortcomings by way of example, suppose there are 5000 Assets in a hierarchy, and a user would like to query top Assets that have: a left arm; recently being manufactured; and one of its motors exceeding temperature limits. It is recognized herein that such a query on the JSON structure data illustrated in FIGS. 3A and 3B might require special logic, or may otherwise be difficult. Thus, it is further recognized herein that when the Asset Model on the customer end becomes complex over time, the model is difficult to query and difficult to get insights into it. For example, a user might need to write specific logic each time specific information is needed. Given the complexity of a given Asset Model, such querying can be time-consuming and require significant manual effort. For example, a developer might need to write each filter or nesting filter on a given Asset Model manually. Consequently, it is further recognized herein that, in current approaches, users are restricted from getting insights into Asset Model quickly and accurately, for example, due at least in part to the dynamic nature of the data being generated in industry.

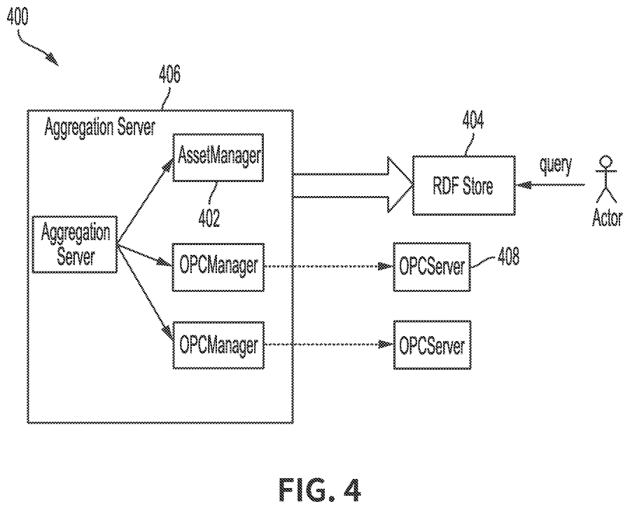

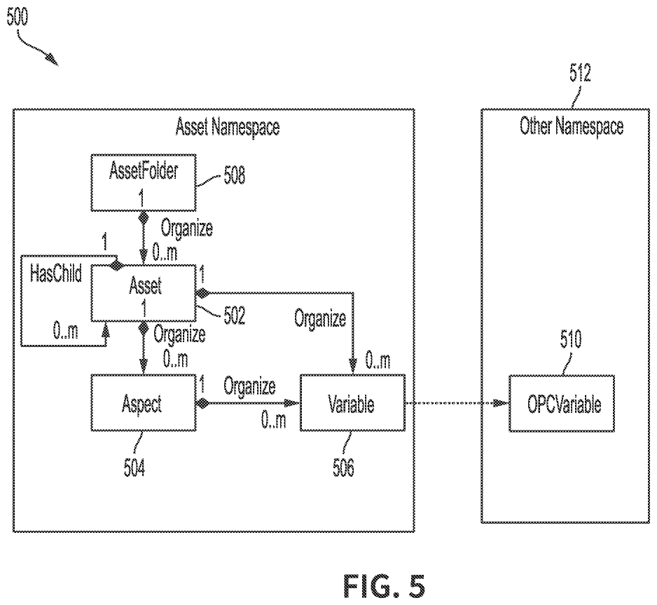

Referring now to FIGS. 4 and 5, the asset modules 106 can define an example system 400 that can define various Asset models, for instance an example Asset model 500, which is integrated into an Open Platform Communications, Unified Architecture (OPC UA) model and can be managed by an Asset Node Manager 402. Users may use the asset model concept, for instance the Asset model 500, to organize data and information from various sources. Thus, in accordance with various embodiments, users can create or generate asset models, for instance the Asset model 500, that are tailored to their respective needs. Such asset models can then be searched via flexible queries. In some cases, a separate asset hierarchy can be created that captures variables from multiple hierarchies of the OPC UA tree into a single outlet. Consequently, users can create their own “views” of the OPC UA system that they are trying to model.

Referring in particular to FIG. 4, the Asset Node Manager 402 can be used to define the Asset model 500, which can be converted to a Resource Description Framework (RDF) knowledge graph or store 404 for query. Asset models described herein, for instance the Asset model 500, can be composed of custom objects. The custom objects can define a structure or folder that contain further objects. Such further objects can define asset variables that correspond to, or connect with, OPC UA variables (e.g., temperature, etc.) By way of example, the Asset model 500 can include an asset variable 506 that corresponds to an OPC variable 510. The aforementioned object structure including the Asset model 500 can be converted into an RDF graph that defines RDF triples that are representative of, and contain information about, relationships between OPC UA entities. For example, the RDF store 404 can define a database that stores the RDF graphs that define how triples (or nodes) connect to other nodes, thereby forming a graph. Thus, unless otherwise specified, the RDF store 404 can be referred to interchangeably herein as the RDF graph or the RDF database, without limitation. The Asset Node Manager 402 can define an OPC UA Node manager within an aggregation server 406. For example, the aggregation server 406 can provide a restful API interface that allows end users to Create/Update/Delete/Query various assets, aspects, and variables, for instance an asset 502, aspect 504, and variable 506 of a given data model, in particular the Asset model 500. Thus, in accordance with the example, the Asset Node Manager 402 manages the Asset model 500.

With continuing reference to FIG. 5, the assets of the Asset model 500, for instance the asset 502, are included in an Asset folder 508 of the industrial information hub (IIH) Core. In various examples, an asset may have a child, so as to define a child-asset or sub-asset. The relation between an Asset and its sub-asset can be referred to in accordance with OPC UA as “HasChild”. A given asset may have multiple aspects. The relation between asset and aspect in accordance with the OPC UA is referred to as “Organize”. An asset can also have a variable directly under it, or the variables may be organized under aspects. In various examples, an asset variable, for instance the variable 506, may have a reference to another OPC UA variable, for instance an OPC variable 510 in another name space 512. In such a case, for example, any change in the OPC variable 510 can be reflected in the associated asset variable 506.

Unlike other OPC UA models that are registered to the IIH Core, asset models described herein, for instance the asset model 500, are very dynamic and can be changed often. Users can create/update/delete the asset model 500 using a user interface (UI) that makes use of the Restful interface that the IIH Core provides. For example, when there is a change to the asset model 500, the OPC to RDF library can be invoked, such that the graph 404 related to the asset 504 is updated, thereby making the queries possible. The OPC to RDF library can define a separate library with functions that can be called with an OPC UA model. For example, such functions can convert the OPC UA model into an RDF graph that then can be loaded into the central RDF store (e.g., RDF store 404) so as to replace an older asset by the new RDF graph. Asset variables, for instance the asset variable 506, can also subscribe to respective OPC variables, for instance the OPC variable 510. Thus, for example, when the value changes in an OPC source or server 408, for instance when the OPC variable 510 changes, the corresponding value in the aggregation 406 server changes accordingly. Then, in various examples, the asset variable that references the OPC variable within the aggregation server 406 also changes accordingly. Thus, the asset model 500 can define various flexible views of various OPC data.

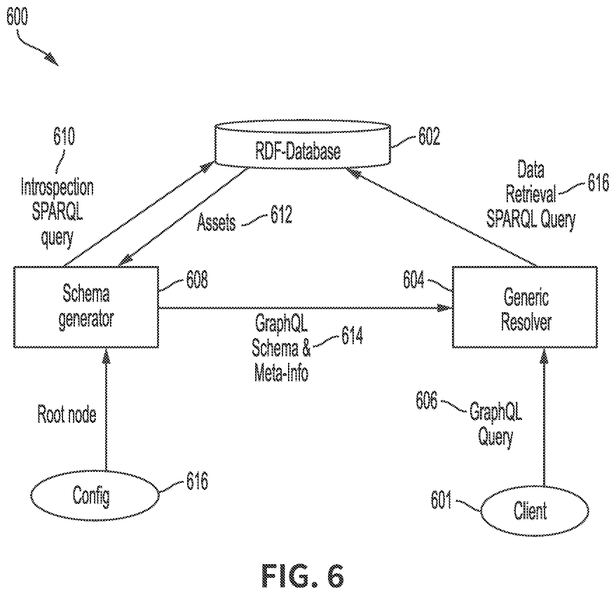

In accordance with various embodiments, users can define logical organizations of data from various sources, so as to generate specific asset models, such as the asset model 500. In various examples, referring also to FIG. 6, an example computing system 600 can define an interface that allows users, for instance clients 601, to perform smart queries on the generated asset models, so as to locate data that they are in interested in obtaining from the asset models. For example, for each asset model node, an artificial OPC UA object can be created and filled with information. The resulting object can be converted into RDF graphs, for example, using an OPC UA to RDF converter. The resulting RDF graphs can be stored in an RDF store or database 602 of the system 600.

In an example, the system includes a semantic GraphQL that can define an automated API generation system that works via automatic introspection of the OPC UA derived RDF ontology. In particular, for example, the system 600 can further include a generic GraphQL server or generic resolver 604 that can provide useful OPC UA semantic knowledge as a GraphQL API. The generic resolver 604 can serve diverse types of auto-generated APIs. The generic server 604 can define components or modules that work in a recursive loop to generically handle client GraphQL requests, for instance GraphQL Queries 606 from the clients 601.

The system 600 can further include an automated schema generator 608 configured to look for assets (e.g., assets 612), aspects, and associated variable nodes in the RDF database 602 by using a SPARQL query 610 to uniquely identify the relationships between assets and underlying OPC UA variables. In particular, for example, the assets in the RDF database 602 can define an associated triple with predicate “is View” set to true. This flag can be used to identify the asset objects. Once such objects are found, a GraphQL datatype “Asset” for each asset is created and populated with associated information about the asset (e.g., GraphQL Schema and Meta-Info 614). For example, the GraphQL can also be flagged with an “isAsset” flag as true in the meta-information 614 that is generated for the resolver 604 to process GraphQL requests or queries 606. The meta-information 614 can contain details associated with generating SPARQL queries 616 to retrieve data for a particular GraphQL object. For example, the meta-information data structure can be augmented to this new “isAsset” flag. This flag can notify the GraphQL or generic resolver 604 that this is a special datatype that requires further processing compared to normal GraphQL types. In some cases, users can set a configuration 616 that defines settings concerning how the schema generator 608 crawls the graph or database 602. In particular, for example, the settings can control how deep the schema generator 608 crawls.

In the generic resolver 604, when a given GraphQL request 606 is made, the resolver 604 looks for the GraphQL type in the request in the meta-information data store (e.g., RDF database 602). The resolver 604 recursively follows the hierarchy of the GraphQL request 606 and the meta-information 614 to progressively SPARQL query (at 616) to the RDF store 602. In accordance with various embodiments, this operation is augmented to include a special processing algorithm for assets. This is activated during the resolving stage when an “isAsset” flag is true for the current GraphQL type being processed. If that is the case, then this special algorithm is applied to retrieve the object data instead of the “normal” operation that does not search for such assets.

The operations performed by the system 600 can including looking for the current asset object of the associated aspect objects using a SPARQL query with the link (at 616). The aspect objects can then be traversed for further subordinate variables using the RDF “hasComponent” predicate. Finally, the underlying data source can be linked with the asset variable using the “Organizes” predicate. The GraphQl resolver 604 can use the SPARQL query (at 616) to traverse these links to find the actual data source and populate the value of the asset variable. This completes the query resolution process, and the final GraphQL response data can be returned to the requesting user, for instance the client 601.

Without being bound by theory, the ability to create an asset model with an associated underlying OPC UA data source can provide ability to create unique views that suites particular user preferences. For example, variables that reside in different parts of the OPC UA tree can be grouped into a single asset. For example, a robot motor temperature can be grouped with a robot controller software version, even though these two data variable reside completely different parts of the data hierarchy. By way of further example, multiple temperature sensors associated with respective robots can be located in different US states. In accordance with various embodiments described herein, these sensors can grouped into an Asset model, such as the Asset model 500, so as to define a single folder (e.g., Asset folder 508) that contains the sensor data from various geographic regions or systems.

Another advantage of the semantic conversion of the asset model into a semantic data storage like RDF is that semantic queries can link various relationships that are connected to the asset model. By way of example, it is possible to query for all assets with a robot motor temperature above a certain treshold selected by the user. Furthermore, by storing the asset model as an RDF graph, semantic information can be input into the asset model. Consequently, is possible discover or determine all the connected arms of a robot, for example, associated with motors that have a temperature above a certain treshold selected by the user. This connection building and semantic information ability provides versatility in query formation and data retrieval. Thus, it will be understood that the asset models are described herein are presented for purposes of example, and alternative asset models and queries can be generated in accordance with a user's needs or interets, and all such alternatively constructed asset models and queries are contemplated as being within the scope of this disclosure.

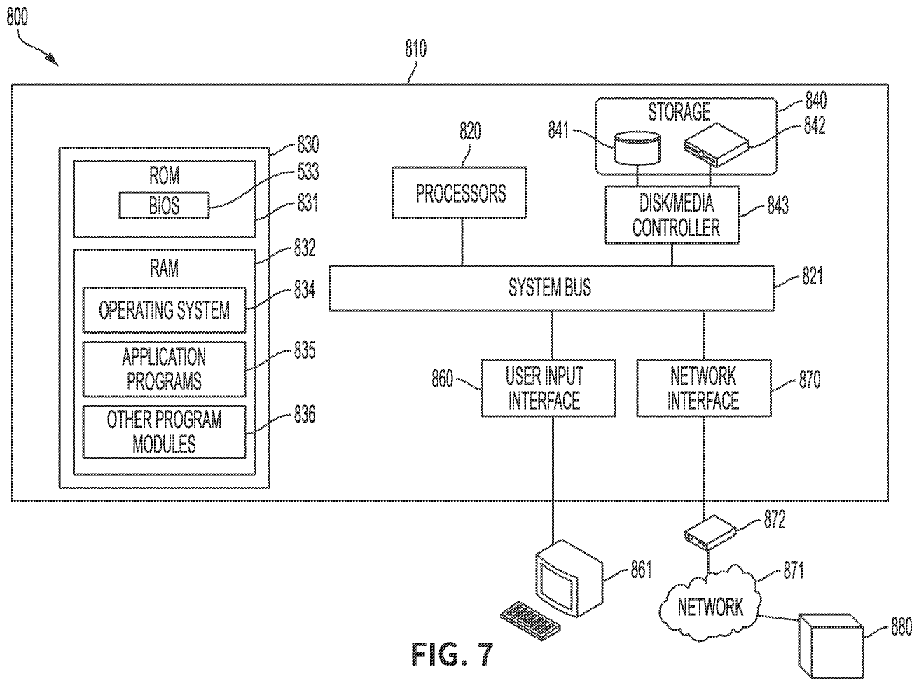

FIG. 7 illustrates an example of a computing environment within which embodiments of the present disclosure may be implemented. A computing environment 800 includes a computer system 810 that may include a communication mechanism such as a system bus 821 or other communication mechanism for communicating information within the computer system 810. The computer system 810 further includes one or more processors 820 coupled with the system bus 821 for processing the information. The system 600 or the system 100, in particular the asset module 106, may include, or be coupled to, the one or more processors 820.

The processors 820 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 820 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 821 may include at least one of a system bus, a memory bus, an address bus, or a message bus, and may permit exchange of information (e.g., data (including computer-executable code), signaling, etc.) between various components of the computer system 810. The system bus 821 may include, without limitation, a memory bus or a memory controller, a peripheral bus, an accelerated graphics port, and so forth. The system bus 821 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 7, the computer system 810 may also include a system memory 830 coupled to the system bus 821 for storing information and instructions to be executed by processors 820. The system memory 830 may include computer readable storage media in the form of volatile and/or nonvolatile memory, such as read only memory (ROM) 831 and/or random access memory (RAM) 832. The RAM 832 may include other dynamic storage device(s) (e.g., dynamic RAM, static RAM, and synchronous DRAM). The ROM 831 may include other static storage device(s) (e.g., programmable ROM, erasable PROM, and electrically erasable PROM). In addition, the system memory 830 may be used for storing temporary variables or other intermediate information during the execution of instructions by the processors 820. A basic input/output system 833 (BIOS) containing the basic routines that help to transfer information between elements within computer system 810, such as during start-up, may be stored in the ROM 831. RAM 832 may contain data and/or program modules that are immediately accessible to and/or presently being operated on by the processors 820. System memory 830 may additionally include, for example, operating system 834, application programs 835, and other program modules 836. Application programs 835 may also include a user portal for development of the application program, allowing input parameters to be entered and modified as necessary.

The operating system 834 may be loaded into the memory 830 and may provide an interface between other application software executing on the computer system 810 and hardware resources of the computer system 810. More specifically, the operating system 834 may include a set of computer-executable instructions for managing hardware resources of the computer system 810 and for providing common services to other application programs (e.g., managing memory allocation among various application programs). In certain example embodiments, the operating system 834 may control execution of one or more of the program modules depicted as being stored in the data storage 840. The operating system 834 may include any operating system now known or which may be developed in the future including, but not limited to, any server operating system, any mainframe operating system, or any other proprietary or non-proprietary operating system.

The computer system 810 may also include a disk/media controller 843 coupled to the system bus 821 to control one or more storage devices for storing information and instructions, such as a magnetic hard disk 841 and/or a removable media drive 842 (e.g., floppy disk drive, compact disc drive, tape drive, flash drive, and/or solid state drive). Storage devices 840 may be added to the computer system 810 using an appropriate device interface (e.g., a small computer system interface (SCSI), integrated device electronics (IDE), Universal Serial Bus (USB), or FireWire). Storage devices 841, 842 may be external to the computer system 810.

The computer system 810 may also include a field device interface 865 coupled to the system bus 821 to control a field device 866, such as a device used in a production line. The computer system 810 may include a user input interface or GUI 861, which may comprise one or more input devices, such as a keyboard, touchscreen, tablet and/or a pointing device, for interacting with a computer user and providing information to the processors 820.

The computer system 810 may perform a portion or all of the processing steps of embodiments of the invention in response to the processors 820 executing one or more sequences of one or more instructions contained in a memory, such as the system memory 830. Such instructions may be read into the system memory 830 from another computer readable medium of storage 840, such as the magnetic hard disk 841 or the removable media drive 842. The magnetic hard disk 841 and/or removable media drive 842 may contain one or more data stores and data files used by embodiments of the present disclosure. The data store 840 may include, but are not limited to, databases (e.g., relational, object-oriented, etc.), file systems, flat files, distributed data stores in which data is stored on more than one node of a computer network, peer-to-peer network data stores, or the like. The data stores may store various types of data such as, for example, skill data, sensor data, or any other data generated in accordance with the embodiments of the disclosure. Data store contents and data files may be encrypted to improve security. The processors 820 may also be employed in a multi-processing arrangement to execute the one or more sequences of instructions contained in system memory 830. In alternative embodiments, hard-wired circuitry may be used in place of or in combination with software instructions. Thus, embodiments are not limited to any specific combination of hardware circuitry and software.

As stated above, the computer system 810 may include at least one computer readable medium or memory for holding instructions programmed according to embodiments of the invention and for containing data structures, tables, records, or other data described herein. The term “computer readable medium” as used herein refers to any medium that participates in providing instructions to the processors 820 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 841 or removable media drive 842. Non-limiting examples of volatile media include dynamic memory, such as system memory 830. Non-limiting examples of transmission media include coaxial cables, copper wire, and fiber optics, including the wires that make up the system bus 821. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 800 may further include the computer system 810 operating in a networked environment using logical connections to one or more remote computers, such as remote computing device 880. The network interface 870 may enable communication, for example, with other remote devices 880 or systems and/or the storage devices 841, 842 via the network 871. Remote computing device 880 may be a personal computer (laptop or desktop), a mobile device, a server, a router, a network PC, a peer device or other common network node, and typically includes many or all of the elements described above relative to computer system 810. When used in a networking environment, computer system 810 may include modem 872 for establishing communications over a network 871, such as the Internet. Modem 872 may be connected to system bus 821 via user network interface 870, or via another appropriate mechanism.

Network 871 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 810 and other computers (e.g., remote computing device 880). The network 871 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 871.

It should be appreciated that the program modules, applications, computer-executable instructions, code, or the like depicted in FIG. 7 as being stored in the system memory 830 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 810, the remote device 880, and/or hosted on other computing device(s) accessible via one or more of the network(s) 871, may be provided to support functionality provided by the program modules, applications, or computer-executable code depicted in the figures and/or additional or alternate functionality. Further, functionality may be modularized differently such that processing described as being supported collectively by the collection of program modules depicted in the figures may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in the figures may be implemented, at least partially, in hardware and/or firmware across any number of devices.

It should further be appreciated that the computer system 810 may include alternate and/or additional hardware, software, or firmware components beyond those described or depicted without departing from the scope of the disclosure. More particularly, it should be appreciated that software, firmware, or hardware components depicted as forming part of the computer system 810 are merely illustrative and that some components may not be present or additional components may be provided in various embodiments. While various illustrative program modules have been depicted and described as software modules stored in system memory 830, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method, the method comprising:
based on user selections, generating an industrial asset model comprising assets from a plurality of different sources, the assets defined in accordance with an Open Platforms Communication United Architecture (OPC UA);
converting the assets from the OPC UA to a resource description format (RDF) knowledge graph;
storing the RDF knowledge graph in a database;
receiving a query for industrial data; and
responsive to the query for industrial data, extracting, from the database, at least two of the assets from the plurality of sources, the at least two assets representative of the industrial data.

2. The method as recited in claim 1, the method further comprising:
receiving, via a Restful interface, a request associated with a change to the asset model; and
responsive to the request, adjusting an asset of the asset model in accordance with the change, so as to define an adjusted asset.

3. The method as recited in claim 2, the method further comprising:
updating the RDF graph in accordance with the adjusted asset.

4. The method as recited in claim 1, wherein the asset model defines an asset variable that subscribes to a respective OPC source of the asset variable, the method further comprising:
based on subscribing to the OPC source, identifying a change to the OPC source; and
updating the asset variable responsive to identifying the change to the OPC source.

5. The method as recited in claim 1, the method further comprising:
receiving the query compliant with a GraphQL API, so to define a GraphQL query;
converting the GraphQL query to a query compliant with SPARQL, so as to define a SPARQL query; and
formatting the at least two assets representative of the industrial data in a format selected by a user.

6. A computing system comprising:
a memory having a plurality of modules stored thereon; and
a processor for executing the modules, the modules configured to:
based on user selections, generate an industrial asset model comprising assets from a plurality of different sources, the assets defined in accordance with an Open Platforms Communication United Architecture (OPC UA);
convert the assets from the OPC UA to a resource description format (RDF) knowledge graph;
store the RDF knowledge graph in a database;
receive a query for industrial data; and
responsive to the query for industrial data, extract, from the database, at least two of the assets from the plurality of sources, the at least two assets representative of the industrial data.

7. The system as recited in claim 6, the modules further configured to:
receive, via a Restful interface, a request associated with a change to the asset model; and
responsive to the request, adjust an asset of the asset model in accordance with the change, so as to define an adjusted asset.

8. The system as recited in claim 7, the modules further configured to:
update the RDF graph in accordance with the adjusted asset.

9. The system as recited in claim 6, wherein the asset model defines an asset variable that subscribes to a respective OPC source of the asset variable, and the modules are further configured to:
based on subscribing to the OPC source, identify a change to the OPC source; and
update the asset variable responsive to identifying the change to the OPC source.

10. The system as recited in claim 6, the modules further configured to:
receive the query compliant with a GraphQL API, so to define a GraphQL query;
convert the GraphQL query to a query compliant with SPARQL, so as to define a SPARQL query; and
format the at least two assets representative of the industrial data in a format selected by a user.
